(19) United States
(12) Patent Application Publication
(10) Pub. No.: US 2018/0101869 A1
(43) Pub. Date: Apr. 12, 2018

(54) METHOD AND INFORMATION SYSTEM FOR ENHANCED TRAVELER EXPERIENCE DURING TRAVEL

(71) Applicant: Theocharis ZACHARATOS, Nicosia (CY)

(72) Inventor: Theocharis ZACHARATOS, Nicosia (CY)

(73) Assignee: CELLOCK LTD, NICOSIA (CY)

(21) Appl. No.: 15/289,209

(22) Filed: Oct. 10, 2016

(51) Int. Cl. G06Q 30/02; G06Q 10/02

(52) U.S. Cl. CPC G06Q 30/0261; G06Q 30/0269; G06Q 50/01; G06Q 30/0275; G06Q 10/02

(57) ABSTRACT

A Method to provide travellers appropriate information and useful advertisements at all stages of a trip and advertisers the opportunity to reach target audience without being intrusive. A key element is the relevance of information that is provided at every stage of the trip and the balance between information that is pushed to a user's device. The method provides a social graph to record user's actions both online and offline at each stage of the trip. This social graph is then used, together with other data about the trip, to guide the system in providing appropriate information and advertisements.

### BACKGROUND OF THE INVENTION

Travelling is a period that should be highly efficient, as in the case of business travel, or highly enjoyable, as in the case of recreational travel. Unfortunately, though quite frequently travelling ends up being a stressful period. One of the reasons is that people find themselves in an unfamiliar environment, there is lack of information, and there are unpredictable events.

Information available to travellers is at the moment highly fragmented. For example, there are websites that help with bookings of flights, hotels, or trains. Airline apps inform about the status of a flight; taxi booking apps help with taxi booking; airport websites allow travellers to search for shops in the airport.

However, there are no integrated systems that provide travellers with all the information they need at every stage of their travel, in a timely manner, and without annoying the user with unnecessary advertisements that are pushed to his mobile device. A key issue is the relevance of information or advertisements and the balance between information that is pushed to a mobile device and information that is simply made available. There are many systems that seek to determine relevance of information but none available in relation to the stages of a trip, specifically designed to address the needs of travellers.

It is the objective of this invention to cover the needs of travellers

### SUMMARY OF THE INVENTION

The present invention provides a method to provide travellers appropriate information and useful advertisements at all stages of a trip, and advertisers the opportunity to reach target audience without being intrusive. Advertisers can reach target audience very effectively by advertisements that are highly targeted both in terms of target audience and in terms of the needs of that audience at a specific point in time.

A trip is divided into a series of stages and information and advertisements are provided on the basis of dynamically defined needs at each stage of the trip. A Social Graph is created by recording a user's actions both online and offline at each stage of the trip. This Social Graph is then used, together with other data about the trip, to guide the system in providing appropriate information and advertisements.

### BRIEF DESCRIPTION OF THE DRAWINGS

The novel features of the invention are set forth in the appended claims. However, for purpose of explanation, non-limiting and non-exhaustive embodiments of the present invention are described with reference to the following drawings, wherein:

FIG. 1 illustrates the overall flow of data and information

FIG. 2 illustrates a typical example of stages of a trip

FIG. 3 examples of information provided at each stage of the trip

FIG. 4 illustrates a travel graph as a subset of a social graph

FIG. 5 illustrates the concept of multiple groups that a traveler belongs to

FIG. 6 Illustrates online and offline cookies

FIG. 7 illustrates generation of cookies at different stages of the trip

FIG. 8 illustrates an example of generation of cookies by virtual and physical behavior

FIG. 9 illustrates how a user's location is interpreted in relation to proximity to defined entities according to local map

FIG. 10 illustrates methods of assessing relevance

### DETAILED DESCRIPTION OF THE PREFERRED EMBODIMENTS

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

The primary objective of this invention is to provide an enhanced experience to travelers, during the entire duration of travel; making available highly relevant information in a timely manner provides such enhanced experience. While advertisements are also provided, a primary qualifying criterion for those advertisements is relevance to the traveler at the specific point in time that the advertisement is received.

We herewith describe a method to achieve this primary objective.

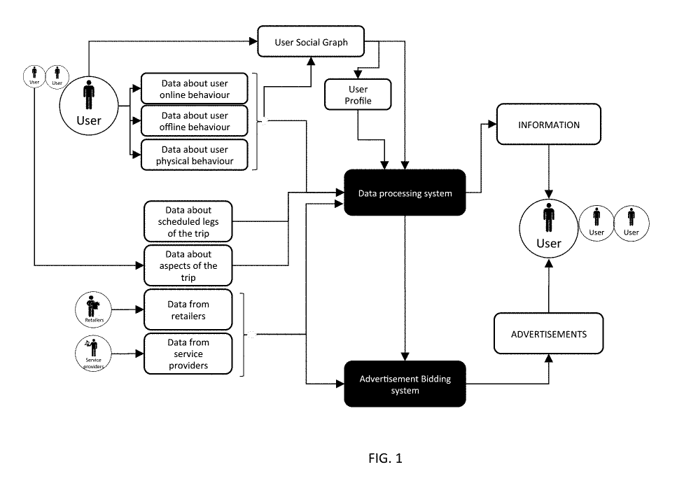

FIG. 1 illustrates the overall schema of the invention. The process comprises the collection of data at each stage of the trip, processing the data, and then providing information and advertisements in a targeted and timely manner to users.

The invention comprises a method which is implemented via a software system in the form of a software application.

Data collection: The system records all the user's activity involved in booking a trip. Depending on the type of ticket booked, the system forms respective tags that are connected with the user's travel graph. Some types of travel booked include but are not limited to airplane, boat, train, car, or bus. After an analysis of a user's preferences (destination, type of accommodation, purpose of trip), the system identifies relevant advertisements that will enable the user to make a booking. After a booking is made the system automatically records and inserts the itinerary details (elaborate itinerary details) on the user's personal travel graph (reference). As an example, Points of Interests, tourist attractions, hotels, car rentals, shows and other things to do, will be made available to the user depending on the destination selected and the purpose of the trip be it business, recreational or leisure.

Activation of the software application: The user may activate the software application and indicate the intention to plan a trip at the first instance that a new trip is being planned. Alternatively, if the application is already active and running at the background, all data will be collected and processed automatically.

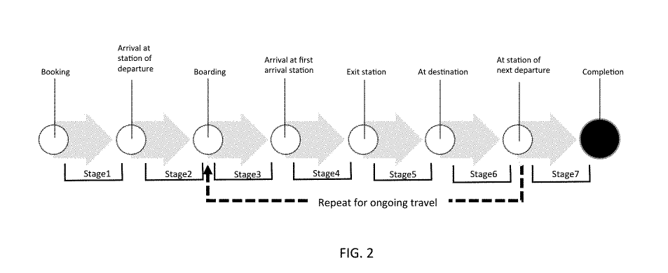

A key element of the system is that relevant information is provided at every stage of the trip, and the trip as a whole has a continuity. FIG. 2 illustrates stages of travel for a preferred embodiment of the invention. It is understood that the stages of travel may be arranged in alternative ways without affecting in any manner the essence of the invention. For example, stages of travel may be modified to include presence at the hotel and exit from the hotel. Stages of travel may also be different for a business trip as compared to a recreational trip.

In this preferred embodiment as illustrated by FIG. 2, there are seven stages as follows:

Stage 1: Booking

Stage 2: period from booking to arrival at station of first departure

Stage 3: period from arrival at station of first departure to boarding for departure

Stage 4: period from first departure to first arrival

Stage 5: period from first arrival to station of arrival to exiting station of arrival

Stage 6: period at destination

Stage 7: arrival at station for next departure

Stage 8: Trip completion

Stage 1:

Stage 1 is considered as the booking stage. As the user explores trip options by visiting different trip planning and trip booking sites, data is collected about this activity. Trip booking sites may include bookings for any mode of travel such as for example flights or trains. Trip booking sites may also include booking for accommodation, and any other booking or planning related to travel. If the trip involves several stop-overs, such as for example connecting flights or transfers between airports terminals, these are recorded as an integral part of the trip.

During the booking stage data is collected both from user's online behaviour preferences, places of interest, choices made among available alternatives. Data is also collected from booking sites or travel companies that are connected to the software system of this invention.

Stage 2:

Stage 2 includes the period from booking to arrival at station of first departure. Stage 2 may be considered as preparation stage for the trip. If for example the first leg of the trip involves a flight, this stage would include the period from booking to arrival at the airport.

Stage 3:

Stage 3 includes the period from arrival at station of first departure to boarding for departure. For example, when the mode of travel is air travel, this stage includes the period from arrival to the airport terminal to boarding the airplane. For example, once the user is in the departure lounge, the system tracks physical behaviour such as location, movement, purchases, social interactions.

Stage 4:

Stage 4 includes the time period from first departure to first arrival. The user would be at this period on the mode of transport, for example on board the airplane. At this stage the user may generally not have access to internet and the system may be operating in offline mode.

If the system is indeed operating in offline mode, then any information provided would be on the basis of the data that was collected and stored previously.

Stage 5:

Stage 5 includes the period from first arrival to station of arrival to exiting station of arrival. During this stage the user is in the arrival lounge of their respective destination. If for example the arrival station is an airport, this would be the period from arrival gate to exiting through passport control and customs if applicable. This stage involves several points where availability of relevant information in a timely manner would be critical. For example, at this stage, users may need to collect any checked-in luggage. In the unfortunate event that the luggage is missing, information on available options, reports, items of first need to purchase and so are may be critical. This is also the stage of the tip where some form of ongoing travel is necessary and may or may not have been arranged in advance. One example of such ongoing travel may be a connecting flight, where there may be a limited time to reach the boarding gate. Another example of ongoing travel may be a taxi connection. Information for smooth transfer from one mode of travel to another mode of travel is considered very important for many travellers.

Stage 6:

This stage describes the period at destination. Typically, the user may have explored options on what to do and where to go at destination. The system will act as guidance to the user at destination, utilising all data available in combination with user's location data and the updated Travel and Social Graph to provide relevant information and advertisements in a very timely manner.

Stage 7:

This stage concerns the period until next departure. This stage is accessed when there are intermediate stops before reaching their final destination, and during the inbound leg of the travel for return to base.

Stage 8:

This is the stage that describes trip completion after arrival at initial station, the user's base. After the trip is completed and the traveller has returned back home, the system updates the traveller's personal travel graph with all the information gathered during their trip: choice of restaurants, places visited, what transportation was used, details of any membership cards accessed or created, all recreational activities.

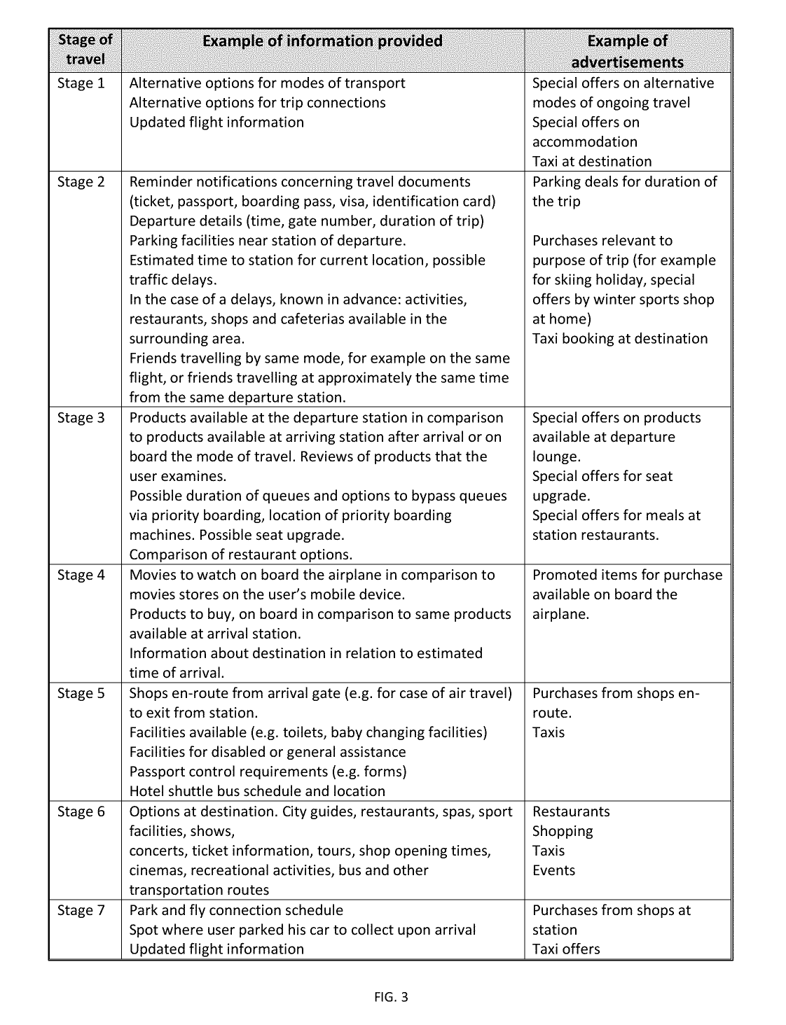

FIG. 3 provides examples of the information and advertisements provided at each stage of a trip. The stages of a trip are according to FIG. 2 as per one preferred embodiment. FIG. 3 provides some examples, and it is understood that many other types of information and advertisements may be provided.

The information provided is always on the basis of relevance at each stage of the trip, and at each point in time depending on the user's prior online or offline behaviour and the user's physical behaviour, and in relation to positional data.

Information provided can in general be distinguished into two categories: a) Information about primary aspects of the trip, and b) information about other possible actions.

Information about primary aspects of the trip comprises:
information about other travel modes and ongoing travel
information about alternative accommodation arrangements
information in relation to options available in case deviation of travel from plan

Information in relation to options available in case of deviation of travel from plan concerns all the information that the user would find useful in minimising the disruption and discomfort. Deviation of travel from plan may comprise the following conditions: delays, diversion, lost luggage, weather change, security risks, or natural disasters; disruption in relation to ongoing travel; delay or cancellation of connecting mode of travel; no show of greet-and-meet taxi.

Information provided to users comprises among other things, options available to users in relation to the disruption. Such options may comprise alternative travel arrangements, alternative accommodation arrangements, or purchase of basic necessities.

The advertisements provided, always have to satisfy a minimum threshold of relevance at each stage of the trip, and at each point in time depending on the user's prior online or offline behaviour and the user's physical behaviour, and in relation to positional data. Once this threshold of relevance is satisfied, advertisements are selected on the basis of a bidding system.

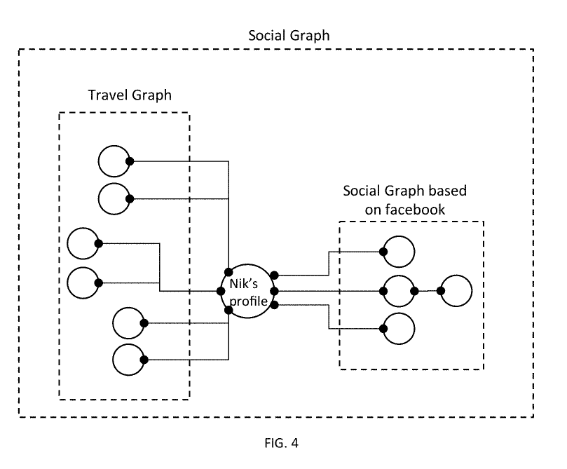

FIG. 4 illustrates how the user's profile is defined based on the Social Graph. This social graph is essentially a representation of user's relationships and they define personal, family, or business communities on social websites or in the real world. In a social graph we can have interconnections among people, groups and organizations. Interdependencies, can be multiple and diverse, including such characteristics or concepts as age, gender, race, travel destinations, genealogy, emotions, ideas, financial transactions, trade relationships, political affiliations, club memberships, occupation, education and economic status. Users may have various social graphs. For example, all Facebook members have a Facebook social graph. These social graphs may be connected. For example, as shown in FIG. 4, a fictional user “Nik” has a social graph based on Facebook and a travel graph. The travel graph is created by linking entities such as co-travelers which may be considered as nodes, via edges which may be considered as tags that assigned through the virtual behavior of the used online and offline as well as the physical behavior of the user.

The various social graphs of a user exist in the system and are also connected with edges. When a user starts the travel in stage 1 and connects with the system, a graph and vertices (tags) concerning the current activity are created. Along his journey between stages the user travel graph is constantly updated with more vertices added and more edges connecting them. Another feature in the graph is date and time. Date and Time is attached to the graph as a separate vertex.

In social graphs, the representation of the nature and strength of relationships between users is based on actual interaction travel data or social groups that they belong,

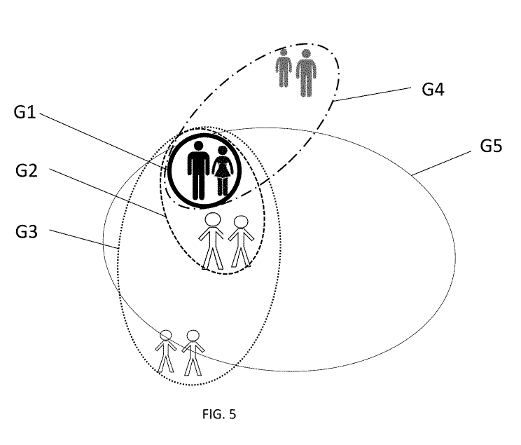

As illustrated by FIG. 5 users are considered as belonging to several social groups. These social groups can be modified at any point during the trip. In one preferred embodiment of the invention, five groups are defined:

Group 1 (G1): User's family and spouse,

Group 2 (G2): User's Co-travellers like family, friends and business colleagues under the same booking

Group 3 (G3): People travelling on the same trip same mode (e.g. on the same flight), but not on the same booking

Group 4 (G4): People that have taken the same trip before or that have travelled from the same departure to the same destination before,

Group 5 (G5): The broader social groups of the user like social network groups.

The Social Graph of the user, including the Travel Graph, is structured taking into consideration the various groups as illustrated in FIG. 5 and described above. The user's Graph is updated based on virtual behaviour online and offline, and physical behaviour. Tags related to real and virtual actions of the user are assigned to the user and incorporated to his Travel Graph.

A Graph links users of all groups according to their relationship. This graph remains operational both online and offline. A user has his Personal Travel Graph that characterises the user in relation to the other users of different groups. When the user is online his Personal Travel Graph is updated in relation to associations that refer to what is happening to other groups. When the user goes offline, his Personal Travel Graph is updated only with regards to his own actions that can be registered offline (Personal Travel Offline Graph—PTOG) on personal electronic device. This Personal Offline Travel Graph is linked to a Group offline graph which contains the preferences and actions of member in Group 2 (G2) and Group 3 (G3) that are travelling on the same transportation means (e.g. on the same flight). When the user is online again the PTOG is used to update the users Personal Travel Graph that is related to up to date associations that refer to what is happening to other groups. Decisions for sending out information or advertisement to a user are based on a Graph Analysis that operates both online and offline.

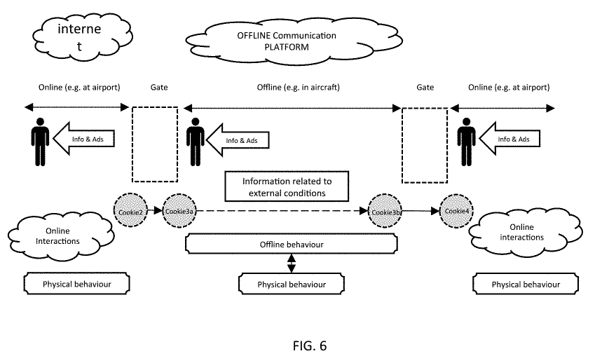

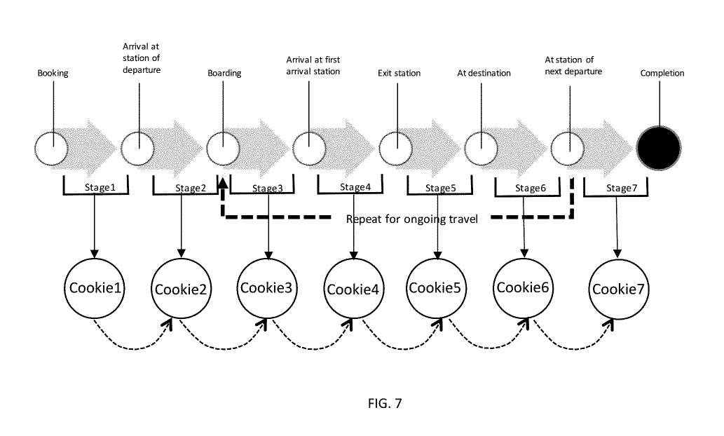

The way that virtual behaviour online and offline, and physical behaviour are registered and processed to update a user's Graph is a key component to the operation of the system. In the preferred embodiment the primary mechanism by which behaviour is captured is via cookies. Cookies are generated at each stage of the trip. As a user passes from one stage of a trip to another, cookies are passed so that the data tags contained in one cookie are used to update other cookies for the next stage of the trip. FIG. 6 and FIG. 7 illustrate for a preferred embodiment how cookies are passed from one stage of the trip to another. Cookies can be both online cookies and offline cookies. For example, a cookie at stage 2 of the trip, referred to as cookie 2, is used to merge the tags with other cookies, cookie 3, that collects data from stage 3 of the trip.

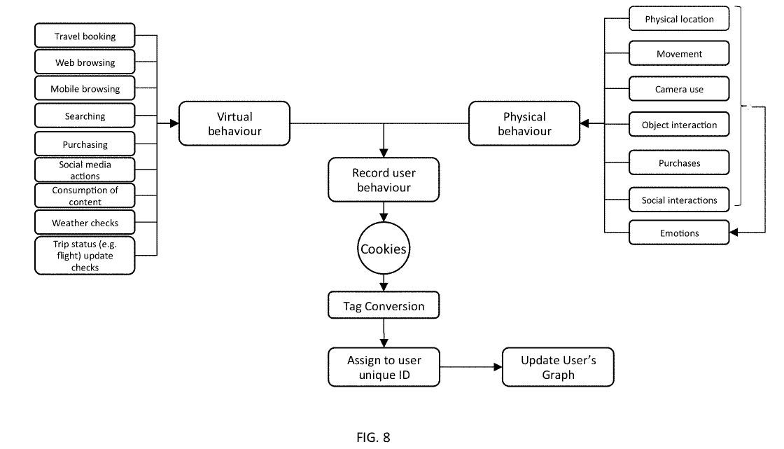

FIG. 8 illustrates by means of example of one embodiment, how virtual and physical behaviour is captured and recorded to create cookies at each stage of the trip, and then convert the tags from these cookies to update a user's Graph. User's social graphs are updated according to both physical and virtual behaviour. Virtual behaviour is captured both when the user in online and when the user is offline. Physical and virtual behaviour is captured by cookies, and the data captured by cookies is converted to tags which are then assigned to the user's unique ID that enables the Travel Graph and hence the Social Graph to be updated.

Regardless of whether the user is online or offline data about the user's physical and virtual behaviour is always captured by cookies. During the different stages of the trip data contained in online and in offline cookies is merged.

The capture of users' physical behaviour is achieved by a plurality of sensors. Some of these sensors are integrated in smart devices, such as a GPS sensor; Other sensors may be wearable sensors worn by some users, such as for example odometer sensors integrated on fitness devices that have become increasingly popular; yet other sensors may be fitted in the surrounding environment such as location sensors that increasingly are applied in shops and even in some airports.

The behaviour captured is always context related to each stage of the trip and is and is interpreted on the basis of other available data at the specific time at each stage of the trip. For example, a user's physical behaviour is detected through sensors as a fast pacing up and down near the departure gate. In this example, other data about the trip may indicate that the flight is being delayed. The physical behaviour detected through the sensors may be interpreted as frustration. The cookie for that stage of the trip will capture the interpretation of the behaviour. In this example the interpretation is an emotion, and specifically the emotion of frustration. The emotion captured by the cookie is then related to other data concerning the trip. The information that is provided to the user is selected and provided in response to the captured emotions. For example, when an emotion captured in case of flight delay is frustration, and based on other trip data the system can conclude that the user is likely to miss a connecting flight, the information provided will provide alternatives in case that the delay continues to the point that the user indeed misses the connecting flight. If in this case for example, the information provided shows that the airline will be able to place the user in an alternative flight 1 hour later, this information can be extremely valuable to the user and may make the user feel relieved.

The user's physical location is one of the most important data captured. The capture of the user's physical location is a key element to the update of the user's profile. A user's profile and a user's Graph is always linked to time and spatial location attributes. Spatial location attributes are always defined in relation to local maps. For example, when a user is an airport his location may be interpreted as being near a departure gate.

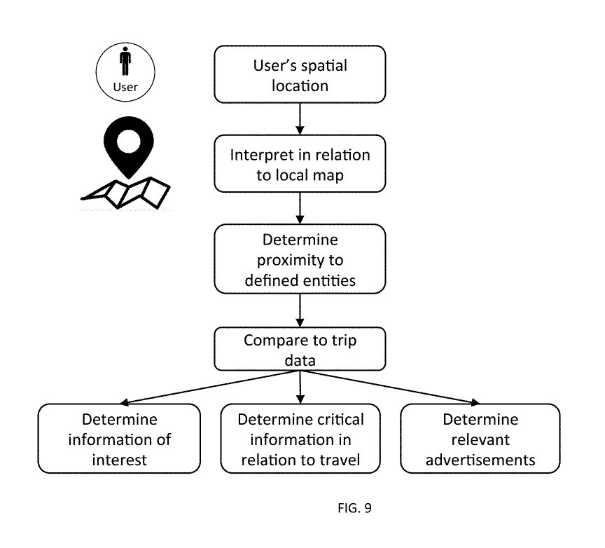

FIG. 9 illustrates how a user's location is interpreted in relation to proximity to defined entities according to local map, then comparing this data to trip data in order to determine the information that needs to be provided to the user or the advertisements that may be relevant for the user. For example, a user may find himself/herself in a situation where his/her location is interpreted as being near a gate, say gate 20. It is possible that the user was thinking that his flight departure was from that gate. For example, when the system compares the spatial location to trip data, relevant trip data at that point in time may be departure gate, say in this example gate 15, and time. This comparison may reveal that the user may need to rush from where he is to gate 15. If the time until close of boarding is short, the system will give an alarm to draw his attention to the message, for example, “Expeditiously proceed to gate 15. Your departure gate is gate 15. Closing in 10 minutes”.

All information provided to the user, according to the invention, needs to be highly relevant. Advertisements also need to be highly relevant, and only advertisements that satisfy a minimum relevance threshold are allowed to go through the advertisement bidding system.

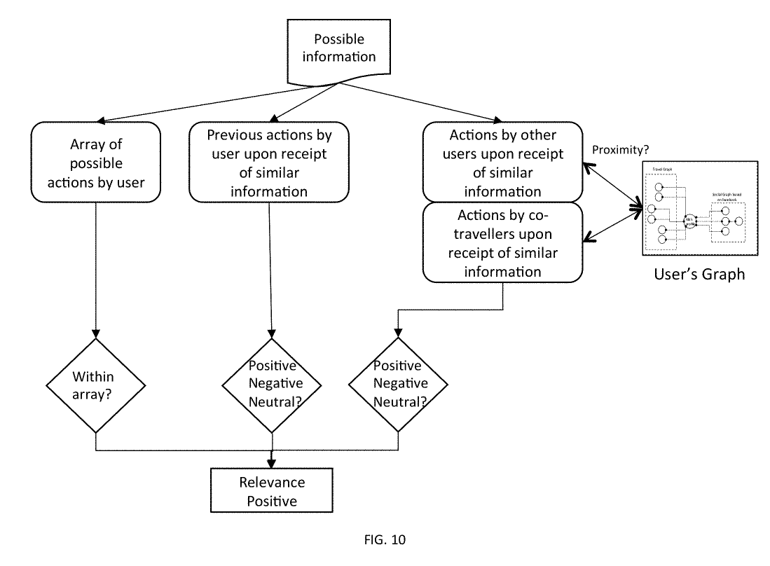

FIG. 10 illustrates the basic methods of assessing relevance according to a preferred embodiment of this invention. Relevance is assessed on the basis of four criteria:
a) The action required by the user in response to the information received falls within the array of possible actions by the user. This means for example that if the information implies that the user will buy something he is indeed in a position to do so given the current circumstances
b) Positive or at least neutral action was taken on the basis of the information (or advertisement) when the user received such information in the past, under similar parameters of the trip.
c) Positive or at least neutral action was taken on the basis of the information (or advertisement) when other users received such information in the past, under similar parameters of the trip.
d) Positive or at least neutral action was taken on the basis of the information (or advertisement) when co-travellers received such information in the past, under similar parameters of the trip. Here co-travellers define, a specific example of a group of users with high logical proximity to the user on the Travel Graph. Other groups may also be used for purposes of assessment of relevance.

Since relevance of information and relevance of advertisements that are provided to users are central to the philosophy of the proposed system and the method according to this invention, the user is able to define the types of information that may be provided. For example, the user may define in the setting of the system that information pushed to his mobile device may only comprise information about aspects of the trip. The user is also able to prioritise the order by which information is provided. For example, the user may assign priority 1 to information regarding trip disruptions.

Information may be provided in different ways. For example, information may be provided as text messages. Such text messages may comprise messages that are pushed to his mobile device via the software app though which the system is implemented. Messages may be pushed to the mobile device in a way that gives an alarm and the message is immediately visible when the mobile device is unlocked. Messages may also be forced as text boxes on top of any other application that the user may be using. The user will have control on the types of messages that are pushed in one way or the other.

Information may also be provided as information made available via the software app of the system. In this case, information can be accessed only when the user intentionally accesses the app.

Information may also be provided in a further mode, via an automated voice operator. The voice operator can be called via the system software app for example or via any other method. When the automated operator is reached via the software app of the system of the present invention, the voice operator will automatically have available all relevant data concerning the user's profile. When the voice operator is called via other telephony means, the user would need to provide a unique identifier code or a unique user name, and this will enable the automated voice operator to access the user's profile data. Once the automated voice operator has access to the user's profile, it can provide all relevant information that the user asks for, in accordance to the user's profile.

For all information that meets the relevance criteria, in addition to user preferences for prioritisation, the system may also automatically prioritise the information provided to the user on the basis of a subscription that various related providers of goods and services have to the system, always subject to similar relevance rating of each piece of information for the user at that point in time and at that spatial location. For example, in the case of cancellation of connecting flight forcing the user to stay overnight near the airport in order to catch a next available flight early next day, the user would need to find suitable accommodation. The user's profile indicates that the user likes 4 star hotels with a minimum rating on the site booking.com of rating 8 or higher. If there are 3 available hotels all having a shuttle bus to the airport, with a small price difference, priority will be given in the order of providing information about the hotels, to the hotel that has a subscription to the system according to this invention.

Relevance is extremely important for information as is for advertisements. All advertisements provided to users must satisfy a minimum relevance criterion. Once the minimum relevance threshold is reached, advertisements are provided on the basis of a relevance and bidding price.

A plurality of relevance criteria may be used, each of these criteria having different weight. This weight is dynamically redefined at each stage of the trip. For example, the weight of the criterion of say desirability of a piece of jewellery is higher at the stage of the trip when the user is at the departure station prior to boarding for departure and has plenty of time until departure, vs the weight of the same item at the stage of the trip when the user has arrived at the destination station.

The weighted criteria for the relevance of advertisements comprise:
inclusion of the goods or services promoted by the advertisement in the array of possible goods or services that the user may need at that stage of the trip;
previous actions of the user in relation to purchases promoted by other advertisers;
previous actions of the user in relation to further clicks in response of advertisements of similar nature received previously by the user;
actions that other users have taken following the receipt of that advertisement, according to the proximity of the target user to users belonging to groups based on the social graph;
actions that co-travellers have taken following the receipt of that information a short time earlier, according to the proximity of the target user to users belonging to groups based on the social graph.

The weighted criteria for the relevance of advertisements also comprise a user's capacity to spend money. This capacity to spend money is determined according to the set of choices for purchases that the user has made during previous stages of the trip and on the basis of price comparison between said choices, and taking into consideration the user's social graph. User's capacity to spend money (UCSM): is an index that is used as a tag that is updated via the online and offline interactions. This index is calculated on the basis of the purchase decisions made by the user when presented with alternative options during in each stage of the trip.

The bidding price of an advertisement is determined in a bidding process where the highest bidder wins. The bidding is a real time process where advertisers bid for publishing slots, just moments earlier than the time that the advertisement would need to be published at that publishing slot. A publishing slot comprises both the publishing spot (physical or virtual location) and the time slot for the period for which the advertisement will be visible.

Advertisements can be distinguished as two types: personal advertisements that can be viewed only by one user on a given media and public advertisements that can be viewed by many users at the same time. For example, personal advertisements comprise advertisements that are pushed to the smart devices of one specific user. Personal advertisements may be viewed both online and offline. Public advertisements, for example, are presented on public displays such as digital signage, electronic billboards and television sets.

Personal Advertisements are targeted to a specific user depending on their Personal Travel Graph and can be viewed on their electronic device.

Public Advertisements can be seen by large crowds which are concentrated together in a specific area. Public advertisements are displayed on the basis of a collective relevance value of many users. Collective relevance value is calculated according to the average of weighted relevance criteria of all users in physical proximity to the advertisement publishing spot within a time slot. Public advertisements that are displayed at a publishing spot at each available time slot are selected provided that the advertisement meets minimum threshold relevance and the advertisement receives the highest bid value in a bidding system.

The system for bidding for advertisements, as part of the method of this invention, is structured and is characterised in that it enables advertisers to prepare budgets based on monthly, weekly, or daily scheduled trips and the profiles of users that will be travelling at a given day, week, or month, that can anonymously be known in advance.

For the purposes of this patent application advertisers mean both direct advertisers and third party automated platforms.

Furthermore, advertisers can utilize specially allocated budgets for trip disruptions. It is well known that during trip disruptions certain goods and services are in high demand. For example, when there is a flight delay, demand for food and drinks may increase. Similarly, when there is a flight delay, demand for taxis at the arrival station may increase, as more people will want to get to their hotel faster, by perhaps taking a taxi rather than public transport. In the case of this example, many users may choose to pre-book a taxi rather than wait that bit of extra time at the queue. It is therefore possible for advertisers to prepare monthly, weekly or daily specially allocated budgets for trip disruptions on the basis of trip relevant information and statistical data on trip disruption for trips from a departure station, for trips to an arrival station, or for trips from one departure station to one arrival station.

The inventors believe that the method of the present invention, and the software system used to implement this method, do indeed provide an enhanced experience during travel as the method ensures that users always receive highly relevant information in a timely manner, tailored to the needs of each stage of the trip, and tailored to the users' specific profiles.

What is claimed:

1. A method for providing an enhanced experience during travel comprising:
creating user profiles based on online and offline behavior of users;
collecting data about a trip based on users travel arrangements;
collecting data regarding a trip from travel companies;
collecting data regarding aspects of the trip from various sources;
collecting data from retailers and service providers for goods and services related to the trip;
and providing information and advertisements to users, said information and advertisements are provided at each stage of the trip according to needs and preferences determined by the profiles of users, and wherein information and advertisements are provided after assessing the effectiveness of said information and advertisements in relation to relevance to users of goods and services that users may obtain at each stage of the trip.

2. A method according to claim 1 wherein stages of the trip comprise:
booking stage;
period from booking to arrival at station of first departure;
period from arrival at station of first departure to boarding for departure;
period from first departure to first arrival;
period from first arrival to station of arrival to exiting station of arrival;
period at destination;
arrival at station for next departure, wherein next departure may comprise an intermediate destination or return to starting point;
and completion of trip.

3. A method according to claim 1 wherein user profiles are defined on the basis of a social graph and wherein said social graph may be used as the database system that stores data into network-like structures, said network-like structures represent a user's relationships on the basis of groups of users defined in the virtual or in the real world and on the basis of shared attributes

4. A method according to claim 3 wherein groups of users may be defined in ways relevant to travel

5. A method according to claim 4 wherein groups of users comprise:
family and spouses;
co-travellers who booked the trip together;
co-travellers who have not booked the trip together;
people that have travelled from the same departure station to the same destination point with the same means and same time;
people that have travelled from the same departure station to the same destination point;
people belonging to other broader groups, said broader groups may be defined in different ways such as professional or social groups with similar demographical or other characteristics.

6. A method according to claim 1, wherein a user's profile is characterized by time and spatial location attributes.

7. A method according to claim 6 characterized in that spatial location attributes are defined in relation to local maps.

8. A method according to claim 1 wherein information provided comprises information that is most relevant at a particular point in time, at each stage of the trip

9. A method according to claim 8 wherein relevance of information is determined on the basis of an array of possible actions by users at each point of time at each stage of the trip

10. A method according to claim 8 or claim 9 wherein relevance of information is determined on the basis of previous actions of the user

11. A method according to claim 8 or claim 9 wherein relevance of information is determined on the basis of actions that other users have taken following the receipt of that information, and taking into consideration the proximity on the social graph of the target user to said other users belonging to groups on the social graph.

12. A method according to claim 8 or claim 9 wherein relevance of information is determined on the basis of actions that co-travellers have taken following the receipt of that information, a short time earlier, and taking into consideration the proximity on the social graph of the target user to said other users belonging to groups on the social graph.

13. A method according to claim 8 wherein information provided comprises information about other travel modes and ongoing travel.

14. A method according to claim 8 wherein information provided comprises information about alternative accommodation arrangements.

15. A method according to claim 8 wherein information provided comprises information in relation to options available in case deviation of travel from plan.

16. A method according to claim 15 wherein said deviation may comprise delays, diversion, lost luggage, weather change, security risks, or natural disasters.

17. A method according to claim 15 wherein said deviation may comprise disruption in relation to ongoing travel.

18. A method according to claim 15 or claim 17 wherein said disruption in relation to ongoing travel may comprise no show of greet-and-meet taxi

19. A method according to claim 15 or claim 17 wherein said disruption may comprise delay or cancellation of connecting mode of travel

20. A method according to claim 15 wherein said options available comprise alternative travel arrangements, alternative accommodation arrangements, or purchase of basic necessities.

21. A method according to claim 1, wherein the user can define the types of information that may be provided to him or her.

22. A method according to claim 1, wherein the user can prioritize the order by which information may be provided.

23. A method according to claim 1, wherein information is provided as text messages.

24. A method according to claim 1, wherein information is provided and accessed only via a smart phone app once the user intentionally accesses that app

25. A method according to claim 1, wherein information is provided by an automated voice operator, wherein said automated voice operator has available all relevant data concerning the user's profile, and wherein said automated voice operator is reached by a simple telephone call.

26. A method according to claim 1, wherein the information provided is prioritized according to an algorithm that takes into consideration subscriptions or fees paid to the system operator by participating retailers or service providers that provide the goods or services that are relevant to the user at that point in time and at that physical location.

27. A method according to claim 1, wherein users' social graphs are updated according to both online and offline behavior.

28. A method according to any of the preceding claims, characterized a user's behavior both online and offline at all stages of a trip is captured by cookies, and wherein when the user is online virtual and physical behavior is captured by cookies, and wherein when the user is offline virtual and physical behavior is also captured by cookies.

29. A method according to claim 28, wherein data contained in offline and online cookies is merged

30. A method according to claims 27 to 29, wherein physical behavior is captured by sensors integrated into smart devices held or by wearable sensors or by sensors in the surrounding environment.

31. A method according to claims 27 to 30, wherein behavior captured is context related to each stage of the trip, and is interpreted on the basis of other available data at the specific time at each stage of the trip.

32. A method according to claim 31, wherein cookies capture said interpretation of behavior.

33. A method according to claim 32, wherein interpretation of behavior comprises emotions.

34. A method according to claim 33, wherein said emotions are related to other data concerning the trip.

35. A method according to any preceding claims, wherein information provided is selected in response to emotions.

36. A method according to claim 1, characterized in that advertisements are provided on the basis of relevance and bidding price, wherein relevance is assessed according to a number of weighted criteria, the weight of said weighted criteria being dynamically redefined for each stage of the trip, and wherein bidding comprises a real time process where advertisers bid for publishing slots.

37. A method according to claim 36, wherein said weighted criteria for relevance of advertisements comprise:
inclusion of the goods or services promoted by the advertisement in the array of possible goods or services that the user may need at that stage of the trip;
previous actions of the user in relation to purchases promoted by other advertisements;
previous actions of the user in relation to further clicks in response of advertisements of similar nature received previously by the user;
actions that other users have taken following the receipt of that advertisement according to the proximity on the social graph of the target user to other users belonging to defined groups of users;
actions that co-travellers have taken following the receipt of that information a short time earlier according to the proximity on the social graph of the target user to other users belonging to defined groups of users.

38. A method according to claim 37, wherein weighted criteria further comprise a user's capacity to spend money.

39. A method according to claim 38, wherein said user's capacity to spend money is determined according to choices for purchases that the user has made during previous stages of the trip on the basis of price comparison between said choices and the user's social graph.

40. A method according to claim 36, wherein advertisements comprise personal and public advertisements, said advertisements are displayed at a given time slot and a given advertising spot, and wherein personal advertisements are pushed to the smart devices of one specific user, and wherein public advertisements are presented on public displays; both personal and public advertisements are displayed on the basis of location of one or more users at a given time, said time may be the same as the advertising time slot or an earlier time than the advertising time slot.

41. A method according to claim 40, wherein public advertisements are displayed on the basis of a collective relevance value for many users.

42. A method according to claim 41, wherein said collective relevance value is calculated according to the average of weighted relevance criteria for all users in physical proximity to the advertisement publishing spot within a time slot.

43. A method according to any of claims 40 to 42, wherein public advertisements that are displayed at a publishing spot at each available time slot are selected on the basis of the highest bid value offered in a bidding system, provided that the advertisement with the highest bid value meets a minimum threshold of relevance value.

44. A system for bidding for advertising time according to any of claims 40 to 43, characterized in that advertisers can prepare budgets based on monthly, weekly, or daily scheduled trips and the profiles of users that will be travelling at a given day, week, or month, that can anonymously be known in advance.

45. A system for bidding for advertising time according to any claims 40 to 44, characterized in that advertisers can utilize specially allocated budgets for trip disruptions.

46. A system for bidding for advertising time according to any claim 45, wherein advertisers can prepare monthly, weekly or daily specially allocated budgets for trip disruptions on the basis of trip relevant information and statistical data on trip disruption for trips from a departure station, for trips to an arrival station, or for trips from one departure station to one arrival station.
